(19) United States
(12) Patent Application Publication
(10) Pub. No.: US 2026/0289956 A1
(43) Pub. Date: Sep. 24, 2026

(54) METHOD, APPARATUS, DEVICE, AND STORAGE MEDIUM FOR IMAGE PROCESSING

(71) Applicant: Beijing Zitiao Network Technology Co., Ltd., Beijing (CN)

(72) Inventor: Sheng ZHANG, Beijing (CN)

(21) Appl. No.: 19/490,880

(22) PCT Filed: May 30, 2024
(86) PCT No.: PCT/CN2024/096350

§ 371 Date: Dec. 5, 2025

(30) Foreign Application Priority Data
Jun. 6, 2023 (CN) 202310667205.4

(51) Int. Cl. G06V 10/75; G06V 10/26; G06V 10/44; G06V 20/20

(52) U.S. Cl. CPC G06V 10/757; G06V 10/267; G06V 10/443; G06V 10/751; G06V 20/20

(57) ABSTRACT

Embodiments of the disclosure provide a method, apparatus, device, and storage medium for image processing, and the method includes: performing line feature extraction on a first image and a second image to be matched, respectively, to obtain a plurality of first line segments and a plurality of second line segments; determining a plurality of first intersection points corresponding to the plurality of first line segments and a plurality of second intersection points corresponding to the plurality of second line segments; matching the plurality of first intersection points and the plurality of second intersection points to obtain a plurality of matching point pairs, wherein each matching point pair comprises a first intersection point and a corresponding second intersection point; and determining a plurality of matched target line segments in the first image and the second image based on the plurality of matching point pairs.

This application claims the benefit of Chinese Patent Application No. 202310667205.4, filed Jun. 6, 2023, entitled “METHOD, APPARATUS, DEVICE, AND STORAGE MEDIUM FOR IMAGE PROCESSING”, which is incorporated herein by reference in its entirety.

### FIELD

Embodiments of the present disclosure relate to the technical field of image processing, and more particularly to a method, apparatus, device, and storage medium for image processing.

### BACKGROUND

With the development of image processing technologies, technicians have developed more and more image processing scenarios such as an image recognition scenario, an augmented reality scenario, or the like. In many image processing scenarios, it may be required to match line segments between two images and identify the same line segment in the two images.

### SUMMARY

Embodiments of the present disclosure provide a method, apparatus, device, and storage medium for image processing.

According to a first aspect, embodiments of the present disclosure provide a method for image processing, including: performing line feature extraction on a first image and a second image to be matched, respectively, to obtain a plurality of first line segments and a plurality of second line segments; determining a plurality of first intersection points corresponding to the plurality of first line segments and a plurality of second intersection points corresponding to the plurality of second line segments; matching the plurality of first intersection points and the plurality of second intersection points to obtain a plurality of matching point pairs, wherein each matching point pair comprises a first intersection point and a corresponding second intersection point; and determining a plurality of matched target line segments in the first image and the second image based on the plurality of matching point pairs.

According to a second aspect, embodiments of the present disclosure provide an apparatus for image processing, including: an extracting module configured to perform line feature extraction on a first image and a second image to be matched, respectively, to obtain a plurality of first line segments and a plurality of second line segments; a first determining module configured to determine a plurality of first intersection points corresponding to the plurality of first line segments and a plurality of second intersection points corresponding to the plurality of second line segments; a matching module configured to match the plurality of first intersection points and the plurality of second intersection points to obtain a plurality of matching point pairs, wherein each matching point pair comprises a first intersection point and a corresponding second intersection point; and a second determining module configured to determine a plurality of matched target line segments in the first image and the second image based on the plurality of matching point pairs.

According to a third aspect, embodiments of the present disclosure provide an electronic device, including: a processor, and a memory communicatively connected to the processor; the memory storing computer-executable instructions; the processor executing the computer-executable instructions stored in the memory to perform the method for image processing according to the first aspect and possible designs of the first aspect.

According to a fourth aspect, embodiments of the present disclosure provide a computer-readable storage medium storing computer-executable instructions that, when executed by a processor, causing the method for image processing according to the first aspect and possible designs of the first aspect to be implemented.

According to a fifth aspect, embodiments of the present disclosure provide a computer program product, comprising a computer program that, when executed by a processor, causing the method for image processing according to the first aspect and possible designs of the first aspect to be implemented.

### BRIEF DESCRIPTION OF DRAWINGS

In order to more clearly illustrate the technical solutions in the embodiments of the present disclosure or related technologies, the accompanying drawings required to be used in the description of the embodiments or related technologies will be briefly described below. It is apparent that the accompanying drawings in the following description are some embodiments of the present disclosure, and other accompanying drawings may be obtained according to these accompanying drawings for those of ordinary skill in the art without creative effort.

FIG. 1 is an application scenario diagram of a method for image processing according to embodiments of the present disclosure;

FIG. 2 is a first schematic flowchart of a method for image processing according to embodiments of the present disclosure;

FIG. 3 is a second schematic flowchart of a method for image processing according to embodiments of the present disclosure;

FIG. 4 is a third schematic flowchart of a method for image processing according to embodiments of the present disclosure;

FIG. 5 is a fourth schematic flowchart of a method for image processing according to embodiments of the present disclosure;

FIG. 6 is a structural block diagram of an apparatus for image processing according to embodiments of the present disclosure;

FIG. 7 is a schematic diagram of a hardware structure of an electronic device according to embodiments of the present disclosure.

### DETAILED DESCRIPTION

In order to make the objectives, technical solutions and advantages of the embodiments of the present disclosure more clear, the technical solutions in the embodiments of the present disclosure will be clearly and completely described below with reference to the accompanying drawings in the embodiments of the present disclosure, and it is obvious that the described embodiments are part of the embodiments of the present disclosure, rather than all of the embodiments. All other embodiments obtained by those skilled in the art based on the embodiments of the present disclosure without creative labor shall fall within the scope of the present disclosure.

It should be noted that the user information (including but not limited to user equipment information, user personal information, etc.) and data (including but not limited to data for analysis, stored data, displayed data, etc.) involved in this application are information and data that are authorized by the user or are sufficiently authorized by all parties, and collection, use and processing of the related data needs to comply with relevant laws and regulations and standards of related countries and areas, and a corresponding operation access is provided for the user to select authorization or denial.

The application scenarios of embodiments of the present disclosure are explained below.

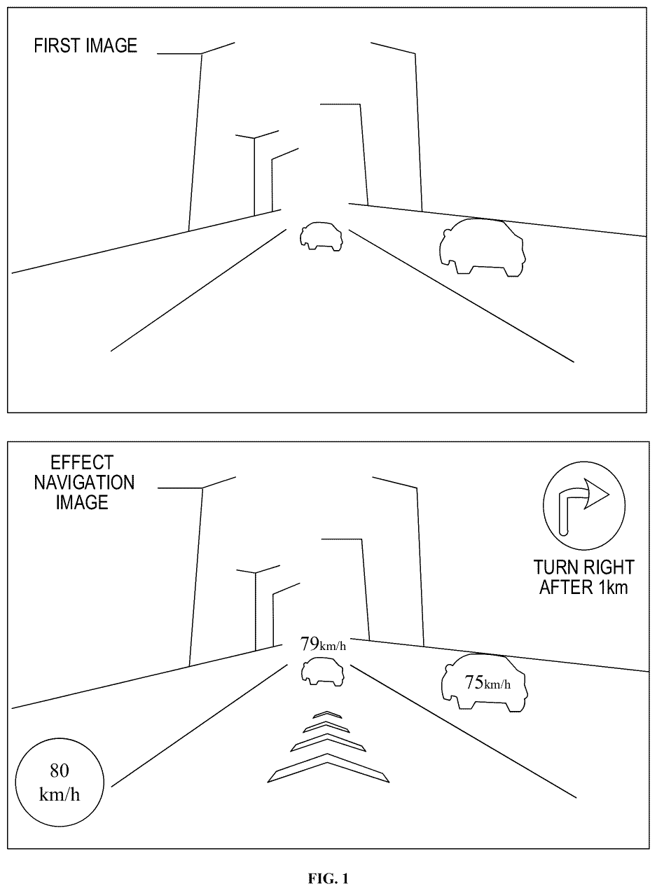

The method for image processing provided in the embodiments of the present disclosure may be applied to a plurality of scenarios. For example, it may be applied to an image comparison scenario. As another example, it may be applied to an augmented reality (AR) navigation scenario. FIG. 1 is an application scenario diagram of a method for image processing according to embodiments of the present disclosure. Specifically, as shown in FIG. 1, a terminal captures an image (a first image in FIG. 1) in real time. The image is used as a query frame to retrieve the closest key frame from a constructed visual map, and then local feature matching is performed on the first image and the key frame by using the method for image processing in this application. Based on this, pose information of the first image is determined, and a corresponding AR navigation effect is added to the first image based on the pose information, to obtain an effect navigation image (such as the effect navigation image in FIG. 1), and finally the effect navigation image is displayed in the terminal.

In the related art, the image processing may perform line segment matching by using an LBD (Line Binary descriptor). According to the method, a piece of pixels around the line segment is formed into a strip area, the gradient relation of the pixels in the strip area is calculated, and the line segments in the two images are matched through the gradient relations of the pixels in the strip areas.

In the above application scenario, because when the LBD is used to match the line segments in the two images, the requirement on the definition of the first image and the second image is relatively high, in response to that a device for acquiring images jitters or the captured image is in relatively low pixel resolution, the accuracy of the pixel gradient in the stripe area will be affected, thereby resulting in poor accuracy of line segment matching.

Therefore, the robustness of using the LBD to match the line segments in image processing is poor.

In order to solve the above problem, the present embodiment provides a method, apparatus, device, and storage medium for image processing. First, line feature extraction is performed on a first image and a second image to be matched, respectively, to obtain a plurality of first line segments and a plurality of second line segments. Then, a plurality of first intersection points corresponding to the plurality of first line segments and a plurality of second intersection points corresponding to the plurality of second line segments are determined. Finally, the plurality of first intersection points and the plurality of second intersection points are matched to obtain a plurality of matching point pairs, and a plurality of matched target line segments in the first image and the second image are determined based on the plurality of matching point pairs. The line segments in the image are extracted by extracting line features in the first image and the second image. Then, the intersection points corresponding to the line segments are determined, it is achieved that the line segments are matched through the association relationship of the points and lines, the stability and accuracy of point feature matching are relatively high, and thus the accuracy and robustness of matching the line segments by the image processing method are improved.

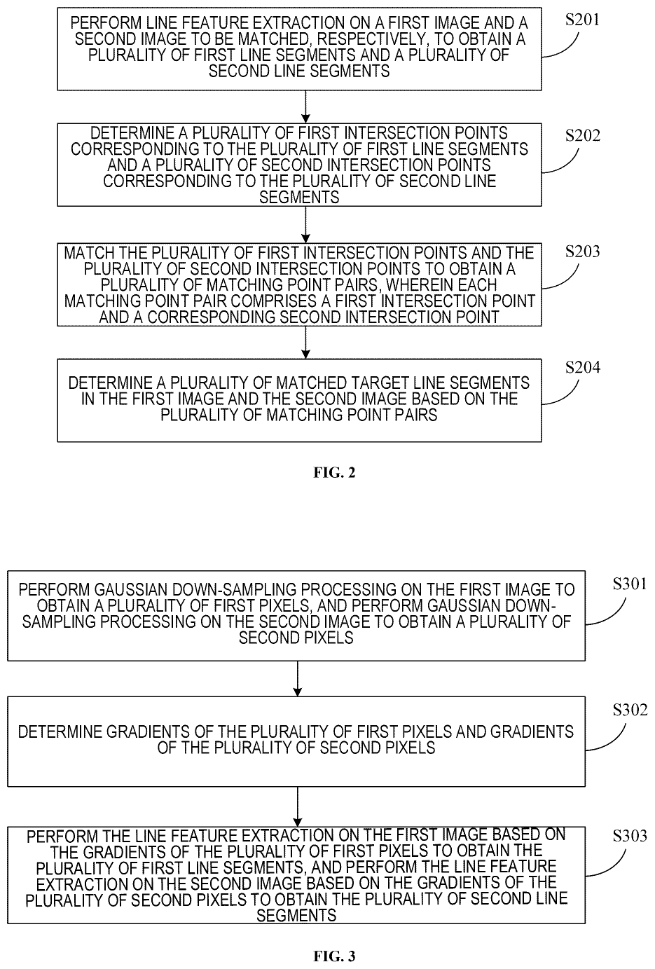

Referring to FIG. 2, FIG. 2 is a first schematic flowchart of a method for image processing according to embodiments of the present disclosure. The method of this embodiment may be applied to an electronic device such as a terminal device and a server, and the image processing method comprises the following steps.
S201: Perform line feature extraction on the first image and the second image to be matched, respectively, to obtain a plurality of first line segments and a plurality of second line segments.

In some embodiments, the first image may be image data acquired in real time based on a camera, and the second image may be image data corresponding to the first image confirmed based on a map of the visual data. Line feature extraction is performed on the first image to obtain a plurality of first line segments, and line feature extraction is performed on the second image to obtain a plurality of second line segments. For example, the first image may be street image data acquired in real time by a camera. The image data may be a picture or a video frame in a video. For example, the second image may be image data determined in a constructed AR navigation map corresponding to the first image (the street image data acquired in real time by the camera).

It should be noted that the first line segment (or the second line segment) may be all line segments of a scene (for example, a vehicle in the image) in a combined image, or may be partial line segments. For example, the first line segment (or the second line segment) may be a boundary line segment forming a traffic indication line such as a roadway, a driving direction, a road edge, a crosswalk and the like in the first image, or may be a boundary line segment of a house contour such as an office building, a cell building, a gas station, or the like, or may be a boundary line segment of a public facility such as a street lamp, a garbage can or the like.
S202: Determine a plurality of first intersection points corresponding to the plurality of first line segments and a plurality of second intersection points corresponding to the plurality of second line segments.

In some embodiments, the extension directions of the plurality of first line segments are the same or different. Some of the first line segments can intersect (or straight lines where the first line segments are located can intersect), and an intersection point where the first line segments (or the straight lines where the first line segments are located) intersect is the first intersection point. Similarly, the extension directions of the plurality of second line segments are the same or different. Some of the second line segments can intersect (or the straight lines where the second line segments are located can intersect), and an intersection point where the second line segments (or the straight lines where the second line segments are located) intersect is the second intersection point.

Optionally, the specific step of determining the plurality of first intersection points and the plurality of second intersection points may comprise: determining a plurality of first straight lines where the plurality of first line segments are located, and determining an intersection point of any two straight lines among the plurality of first straight lines to obtain the plurality of first intersection points; and determining a plurality of second straight lines where the plurality of second line segments are located, and determining an intersection point of any two straight lines among the plurality of second straight lines to obtain the plurality of second intersection points.

The first intersection point may be located at an endpoint, inside, or outside of the first line segment. In some possible cases, the first intersection is located at an endpoint of the first line segment. For example, endpoints of two first line segments intersect and coincide at one point (that is, forming two first line segments in an “L” type), and in this case, the first intersection point is located at an endpoint of the two first line segments. For another example, endpoints of three first line segments intersect and coincide at one point (that is, forming three first line segments in a “Y” type), and in this case, the first intersection point is the endpoint of three first line segments. It should be noted that the coincidence of the endpoints of the two or more first line segments may be that the pixel coordinates corresponding to the endpoints are the same, or may be that the distance between the pixel coordinates corresponding to the endpoints is less than a preset threshold, which is not described herein again.

In other possible cases, an endpoint of one first line segment intersects with the middle of another first line segment (that is, forming two first line segments in a “T” type), and in this case, the first intersection point is located at the endpoint of the one first line segment, and is located inside another first line segment. In other possible cases, the two first line segments may be intersected at middle portions of the two first line segments (that is, forming two first line segments in an “X” type), and in this case, the first intersection point is located inside the two first line segments. In other possible cases, an extension line of a straight line where one first line segment is located intersects with an extension line of a straight line where another first line segment is located (that is, forming two first line segments in a “ [symbol] ” type), and in this case, the first intersection point is located outside the two first line segments.

It should be noted that, after the plurality of first intersection points corresponding to the plurality of first line segments are obtained, the location relationship between the first intersection point and the first line segment to which the first intersection point belongs may be further associated to obtain the location relationship information of the first intersection point and the first line segment. For example, the location relationship information is: the first intersection A is located inside the first line segment A, and is located at an endpoint of the first line segment B.

The second intersection point may be located at an endpoint, inside, or outside of the second line segment. The location relationship between the second intersection point and the second line segment is the same as the location relationship between the first intersection point and the first line segment, which will not be described herein again.
S203: Match the plurality of first intersection points and the plurality of second intersection points to obtain a plurality of matching point pairs, wherein each matching point pair comprises a first intersection point and a corresponding second intersection point.

In some embodiments, the plurality of matching point pairs may be obtained by performing point feature matching on the first image and the second image. Optionally, a feature point of the real scene represented by the first intersection point in the matching point pair and a feature point of the real scene represented by the second intersection point in the matching point pair are the same feature point. For example, the first intersection point may be an intersection point of a street lamp A and a road surface edge L in the first image, and the second intersection point may be an intersection point of the street lamp A and the road surface edge L in the second image.
S204: Determine a plurality of matched target line segments in the first image and the second image based on the plurality of matching point pairs.

In some embodiments, for each matching point pair, at least one first line segment associated with the first intersection point in the matching point pair and at least one second line segment associated with the second intersection point are determined. And two line segments in the at least one first line segment and the at least one second line segment having line segment attributes satisfying a similarity condition are determined as matched target line segments in the first image and the second image, and finally a plurality of target line segments are obtained.

Optionally, the line segment attribute may comprise: an included angle between the line segment and a reference line in the image, or a feature vector used to represent geometric and/or color information of the line segment extracted by using a deep learning model, or a line segment attribute determined by using an existing manner in which the line segment may be described/represented. Correspondingly, the line segment attributes satisfying the similarity conditions comprises: slopes of the line segments are the same/similar (that is, the included angles between the line segments and the reference line in the image are the same/similar), or the feature vectors representing the line segment geometric and/or color information are the same/similar, or the line segment attributes determined by an existing manner in which the line segments are described/represented are the same/similar.

For example, the plurality of matching point pairs comprise: a first intersection point A and a second intersection point A′, a first intersection point B and a second intersection point B′. The at least one first line segment associated with the first intersection point A comprises a first line segment A and a first line segment B; and the at least one first line segment associated with the first intersection point B comprises a first line segment C and a first line segment D. The at least one second line segment associated with the second intersection point A′ comprises a second line segment A′ and a second line segment B′; and at least one first line segment associated with the second intersection point B′ comprises a second line segment C′ and a second line segment D′.

In some embodiments, the plurality of matched target line segments may be determined by determining whether the first line segments A, B, C, D and the second line segments A′, B′, C′, D′ satisfy a line segment attribute similarity condition. Taking the determination of whether the first line segment A and the second line segment A′ are matched target line segments as an example: if the first line segment A and the second line segment A′ satisfy the line segment attribute similarity condition, it is determined that the first line segment A and the second line segment A′ are matched target line segments; if the first line segment A and the second line segment A′ do not satisfy the line segment attribute similarity condition, it is determined that the first line segment A and the second line segment A′ are not matched target line segments. For example, it is determined that in the first line segments A, B, C, D and the second line segments A′, B′, C′, D′, the target line segments satisfying the line segment attribute similarity condition comprise three line segments, respectively: the first line segment A and the second line segment A′, the first line segment C and the second line segment C′, the first line segment D and the second line segment D′ (the first line segment B and the second line segment B′ do not satisfy the line segment attribute similarity condition).

In the embodiments, line feature extraction is performed on the first image and the second image to be matched, respectively, to obtain the plurality of first line segments and the plurality of second line segments. Then, the plurality of first intersection points corresponding to the plurality of first line segments and the plurality of second intersection points corresponding to the plurality of second line segments are determined. Finally, the plurality of first intersection points and the plurality of second intersection points are matched to obtain the plurality of matching point pairs, and the plurality of matched target line segments in the first image and the second image are determined based on the plurality of matching point pairs. The line segments in the image are extracted by extracting the line features in the first image and the second image, then the intersection points corresponding to the line segments are determined, and the line segments are achieved to be matched through the association relationship of the points and lines. Moreover, the stability and accuracy of point feature matching are relatively high, and thus the accuracy and robustness of matching the line segments by the method for image processing are improved.

Referring to FIG. 3, FIG. 3 is a second schematic flowchart of a method for image processing according to embodiments of the present disclosure. Based on the embodiments shown in FIG. 2, the embodiments further refine step S201. In the embodiments, line feature extraction may be performed on the first image and the second image to be matched, respectively, by using an LSD (Line Segment Detector), to obtain a plurality of first line segments and a plurality of second line segments. Specifically, the following steps may be comprised.
S301: Perform Gaussian down-sampling processing on the first image to obtain a plurality of first pixels, and performing Gaussian down-sampling processing on the second image to obtain a plurality of second pixels.

In some embodiments, performing Gaussian down-sampling processing on the first image may reduce or even eliminate a sawtooth effect occurring in the image. The processing degree of the Gaussian down-sampling may be represented by a scaling factor. The scaling factor is a numerical value between 0 and 1, and the smaller the scaling factor is, the more obvious the effect of reducing the sawtooth effect through the Gaussian down-sampling, but the image definition is reduced due to the reduction of the number of acquired pixels. For example, the scaling factor is 0.8, and in this case, the first image is scaled to 80% of the original in both x direction and y direction of are scaled to the original, that is, the total number of pixels is scaled to the 64% of the original.
S302: Determine gradients of the plurality of first pixels and gradients of the plurality of second pixels.

In some embodiments, the gradient of a pixel is the brightness change degree of the pixel, and the gradient of the pixel may be determined by a grayscale value of the pixel. For example, the gradient of each first pixel may be determined by the grayscale value of each first pixel and the grayscale values of the four first pixels below the right thereof, and the specific implementation method is the related art which will not be described herein again. Similarly, the gradient of each second pixel may also be determined by the grayscale value of each second pixel and the grayscale value of the four second pixels below the right thereof.
S303: Perform line feature extraction on the first image based on the gradients of the plurality of first pixels to obtain the plurality of first line segments, and performing line feature extraction on the second image based on the gradients of the plurality of second pixels to obtain the plurality of second line segments.

In some embodiments, the line feature extraction may be achieved by performing region growing based on a seed pixel. Correspondingly, this step comprises: determining a gradient direction of each first pixel based on the gradients of the plurality of first pixels, selecting a first seed pixel from the plurality of first pixels, performing region growing on the first seed pixel based on the gradient direction of each first pixel to obtain a first line support region, and determining a first line segment based on the first line support region; determining a gradient direction of each second pixel based on the gradients of the plurality of second pixels; selecting a second seed pixel from the plurality of second pixels, performing region growing on the second seed pixel based on the gradient direction of each second pixel to obtain a second line support region, and determining a second line segment based on the second line support region.

It should be noted that, based on the gradient direction of each first seed pixel, the first pixels having gradient directions with a small change to that of the first seed pixel and near the first seed pixel may be used as a connected region to perform region growing, to obtain a line support region. The line support region is a strip-shaped rectangle, that is, a first line segment. In some embodiments, the first seed pixel may be randomly selected, and the number of the first seed pixels is a preset number. In some other embodiments, the first seed pixels may also be sequentially selected in an order of small-to-large grayscale values of the first pixels. For example, the grayscale values of the first pixels are sequentially divided into 0 to 255 categories from small to large values, and one or more first pixels are selected from each category as the first seed pixels. Similarly, based on the gradient direction of each second seed pixel, the second pixels having gradient directions with a small change to that of the second seed pixel and near the second seed pixel may be used as a connected region to perform region growing, to obtain a line support region. The line support region is a strip-shaped rectangle, that is, a second line segment.

In the embodiments, since the LSD is used to perform line feature extraction on the first image and the second image to be matched, respectively, and the technology can reduce or even eliminate the sawtooth effect occurring in the image, and can reduce the dependence on the gradient and reduce the noise influence, when line feature extraction is performed on the noisy image, the robustness is improved.

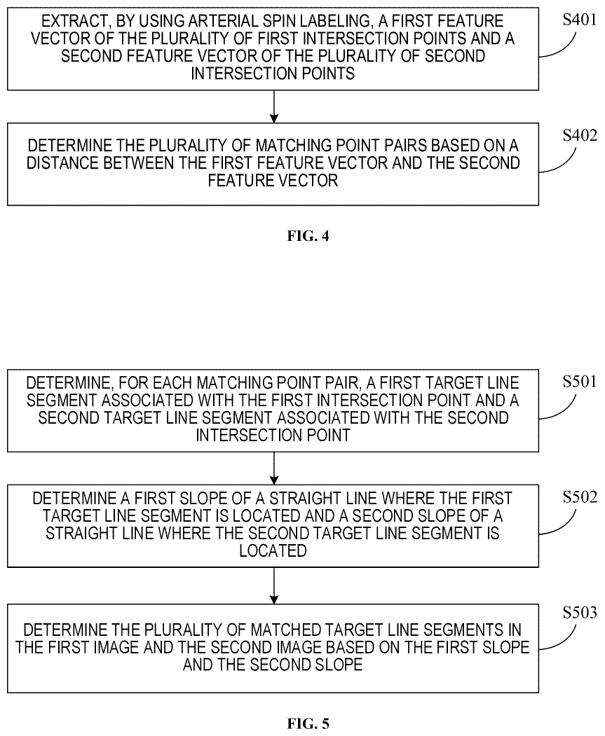

Referring to FIG. 4, FIG. 4 is a third schematic flowchart of an image processing method according to embodiments of the present disclosure. Based on the embodiments shown in FIG. 2, the embodiments further refine step S203. In the embodiments, the plurality of first intersection points and the plurality of second intersection points may be matched using arterial spin labeling (ASL) to obtain a plurality of matching point pairs. As shown in FIG. 4, the method may specifically comprise the following steps.
S401: Extract, by using arterial spin labeling (ASL), a first feature vector of the plurality of first intersection points and a second feature vector of the plurality of second intersection points.

In some embodiments, the first feature vector may comprise first feature information corresponding to the first intersection points. The first feature information is used to represent any attribute information of the first intersection point. Optionally, the first feature information comprises one or more of location information, domain information, and color information. The number of dimensions of the first feature vector is related to a quantity of attribute information that the first feature information represents. For example, the first feature information comprises location information, and the first feature vector of the first intersection point A is (x1, y1); wherein x1 represents a horizontal coordinate of the first intersection point A, and y1 represents a vertical coordinate of the first intersection point A. In this case, the first feature vector is a two-dimensional vector. For example, the first feature information comprises location information and color information, and the first feature vector of the first intersection point A is (x1, y1, c1), wherein x1 represents a horizontal coordinate of the first intersection point A, y1 represents a vertical coordinate of the first intersection point A, and c1 represents a grayscale of the first intersection point A. In this case, the first feature vector is a three-dimensional vector.

In some embodiments, the second feature vector may comprise second feature information corresponding to the second intersection point. The second feature information is used to represent any attribute information of the second intersection point. Optionally, the second feature information comprises one or more of location information, domain information, and color information. The number of dimensions of the second feature vector is related to a quantity of attribute information represented by the second feature information. For example, the second feature information comprises location information, and the second feature vector of the second intersection point A′ is (x2, y2); wherein x2 represents a horizontal coordinate of the second intersection point A′, and y2 represents a vertical coordinate of the second intersection point A′. In this case, the second feature vector is a two-dimensional vector. For example, the second feature information comprises location information and color information, and the second feature vector of the second intersection point A′ is (x2, y2, c2), wherein x2 represents a horizontal coordinate of the second intersection point A′, y2 represents a vertical coordinate of the second intersection point A′, and c2 represents a grayscale of the second intersection point A′. In this case, the second feature vector is a three-dimensional vector.

In a possible implementation, deep learning may be performed on the acquired ASL data for training to obtain an intersection point extraction model. Then, the first feature vector of the plurality of first intersection points and the second feature vector of the plurality of second intersection points are extracted by the model. For example, the intersection point extraction model may be a deep convolutional neural network model.
S402: Determine the plurality of matching point pairs based on a distance between the first feature vector and the second feature vector.

In some embodiments, the first feature vectors comprise first feature information corresponding to the plurality of first intersection points, and the second feature vectors comprise second feature information corresponding to the plurality of second intersection points. Correspondingly, this step comprises: determining, for each first intersection point, distances between the first intersection point and the plurality of second intersection points based on the first feature information of the first intersection point and the second feature information corresponding to the plurality of second intersection points; selecting, from the plurality of second intersection points, a second intersection point meeting a preset distance threshold and having a minimum distance, and combining the second intersection point with the first intersection point as a matching point pair to obtain the plurality of matching point pairs. In the embodiments of the present disclosure, the value of the preset distance threshold is not specifically limited, and may be set and modified as required. For example, the preset distance threshold may be set to 0.5, 1, 2.

Optionally, the distance between the first intersection point and the second intersection point is also the distance between the first feature vector and the second feature vector.

For example, the first feature information comprises location information, and the first feature vector of the first intersection point A is (x1, y1), wherein x1 represents a horizontal coordinate of the first intersection point A, and y1 represents a vertical coordinate of the first intersection point A. The second feature information comprises location information. The first feature vector of the second intersection point A′ is (x2, y2); wherein x2 represents a horizontal coordinate of the second intersection point A′, and y2 represents a vertical coordinate of the second intersection point A′. The distance D between the first intersection point A and the second intersection point A′ is: \sqrt{(X2−X1)²+(y2−y1)²}.

For example, the first feature information comprises location information and color information, and the first feature vector of the first intersection point A is (x1, y1, c1); wherein x1 represents a horizontal coordinate of the first intersection point A, y1 represents a vertical coordinate of the first intersection point A, and c1 represents a grayscale of the first intersection point A. The second feature information comprises location information and color information, and the second feature vector of the second intersection point A′ is (x2, y2, c2); wherein x2 represents a horizontal coordinate of the second intersection point A′, y2 represents a vertical coordinate of the second intersection point A′, and c2 represents a grayscale of the second intersection point A′. The distance D between the first intersection point A and the second intersection point A′ is: \sqrt{(X2−X1)²+(y2−y1)²+(c2−c1)²}.

In the embodiments, since the ASL technology is used to match the plurality of first intersection points and the plurality of second intersection points, the ASL technology is capable of improving the extraction efficiency of the intersection points; and the image noise may be reduced through the ASL technology, the accuracy of extraction of the intersection points can be further improved.

Referring to FIG. 5, FIG. 5 is a fourth schematic flowchart of a method for image processing according to embodiments of the present disclosure. Based on the embodiments shown in FIG. 2, in the embodiments, a specific implementation method of determining a plurality of matched target line segments in the first image and the second image based on the plurality of matching point pairs in step S104 is described in detail. As shown in FIG. 5, the method comprises the following steps.
S501: Determine, for each matching point pair, a first target line segment associated with the first intersection point and a second target line segment associated with the second intersection point.

In some embodiments, an electronic device stores an association relationship between the first intersection point and the first line segment, and an association relationship between the second intersection point and the second line segment. Correspondingly, this step comprises: determining, for each matching point pair, a first target line segment associated with the first intersection point according to the association relationships between the first intersection point and the first line segments; and determining a second target line segment associated with the second intersection point according to the association relationships between the second intersection point and the second line segments.

Optionally, the association relationship between the first intersection point and the first line segment is a location relationship between the first intersection point and the first line segment. For example, the step of determining the first target line segment based on the association relationship comprises: for the first intersection point A in the matching point pair, if the stored association relationship is that the first intersection point A is located in the first line segment A and located at an endpoint of the first line segment B; determining that the first target line segments associated with the first intersection point A are the first line segment A and the first line segment B. Optionally, the association relationship between the second intersection point and the second line segment is a location relationship between the second intersection point and the second line segment. The specific steps of determining the second target line segment are the same as the specific steps of determining the first target line segment, which will not be described herein again.
S502: Determine a first slope of a straight line where the first target line segment is located and a second slope of a straight line where the second target line segment is located.

In some embodiments, the first slope of the straight line where the first target line segment is located is a tangent value of the angle formed between the first target line segment and the positive half-axis of the x-axis of the first image. The second slope of the straight line where the second target line segment is located is a tangent value of the angle formed between the second target line segment and the positive half-axis of the x axis of the second image.
S503: Determine the plurality of matched target line segments in the first image and the second image based on the first slope and the second slope.

In some embodiments, the target line segment whose slope difference is too large in the matching point pair may be screened out based on the slope difference between the first target line segment and the second target line segment. Correspondingly, the specific steps comprise: determining the slope difference between the first slope and the second slope; in accordance with a determination that the slope difference is less than a preset threshold, determining that the first target line segment and the second target line segment are matched target line segments, to obtain the plurality of matched target line segments in the first image and the second image; in accordance with a determination that the slope difference is greater than or equal to the preset threshold, determining that the first target line segment and the second target line segment are not matched. In the embodiments of the present disclosure, the value of the preset threshold is not specifically limited, and may be set and modified as required. For example, the preset threshold may be set to 0.1, 0.2, or 0.3.

In the embodiments, the plurality of matched target line segments are preliminarily determined by the matching point pairs. Then, through the slope difference, the matching point pair with an excessively large slope difference is screened out. Since there is a high probability that the target line segments having an excessively large slope difference are not the line segments at the same position in the first image and the second image (matched target line segments), the accuracy of determining the matched plurality of target line segments is improved.

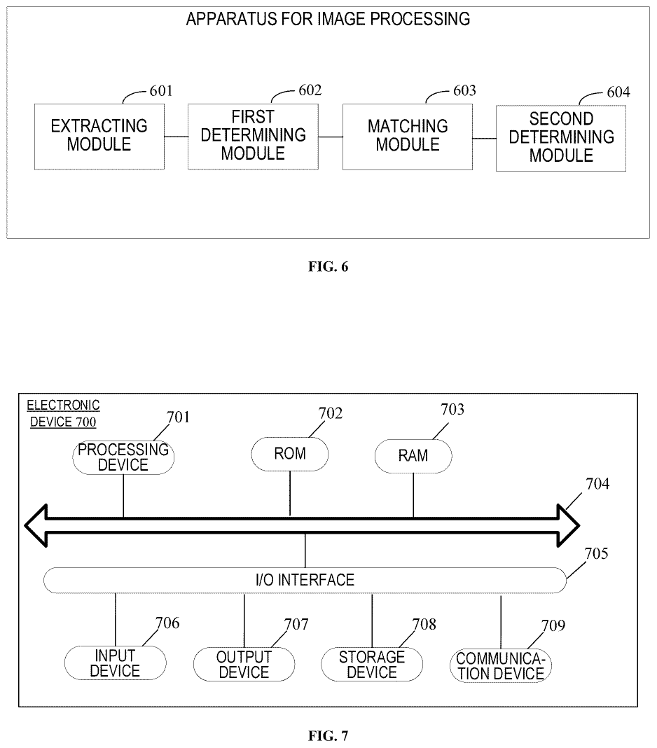

Corresponding to the image processing method in the above embodiment, FIG. 6 is a structural block diagram of an apparatus for image processing according to embodiments of the present disclosure. For ease of illustration, only the portions related to the embodiments of the present disclosure are shown. Referring to FIG. 6, the apparatus for image processing comprises: an extracting module 601, a first determining module 602, a matching module 603, and a second determining module 604. The extracting module 601 is configured to perform line feature extraction on the first image and the second image to be matched, respectively, to obtain a plurality of first line segments and a plurality of second line segments; and the first determining module 602 is configured to determine a plurality of first intersection points corresponding to the plurality of first line segments and a plurality of second intersection points corresponding to the plurality of second line segments.

The matching module 603 is configured to match the plurality of first intersection points and the plurality of second intersection points to obtain a plurality of matching point pairs, wherein each matching point pair comprises a first intersection point and a corresponding second intersection point.

The second determining module 604 is configured to determine a plurality of matched target line segments in the first image and the second image based on the plurality of matching point pairs.

In embodiments of the present disclosure, the extracting module 601 is specifically configured to: perform Gaussian down-sampling processing on the first image to obtain a plurality of first pixels, and perform Gaussian down-sampling processing on the second image to obtain a plurality of second pixels; determine a gradient of the plurality of first pixels and gradients of the plurality of second pixels; perform the line feature extraction on the first image based on the gradients of the plurality of first pixels to obtain the plurality of first line segments, and perform the line feature extraction on the second image based on the gradients of the plurality of second pixels to obtain the plurality of second line segments.

In embodiments of the present disclosure, the extracting module 601 performs line feature extraction on the first image based on the gradients of the plurality of first pixels to obtain the plurality of first line segments, and performs the line feature extraction on the second image based on the gradients of the plurality of second pixels to obtain the plurality of second line segments, and is specifically configured to: determine a gradient direction of each first pixel based on the gradients of the plurality of first pixels, select a first seed pixel from the plurality of first pixels, perform region growing on the first seed pixel based on the gradient direction of each first pixel to obtain a first line support region, and determine a first line segment based on the first line support region; determine a gradient direction of each second pixel based on the gradients of the plurality of second pixels, select a second seed pixel from the plurality of second pixels, perform region growing on the second seed pixel based on the gradient direction of each second pixel to obtain a second line support region, and determine a second line segment based on the second line support region.

In embodiments of the present disclosure, the first determining module 602 is specifically configured to: determine a plurality of first straight lines where the plurality of first line segments are located, and determine intersection points of any two straight lines in the plurality of first straight lines to obtain the plurality of first intersection points; and determine a plurality of second straight lines where the plurality of second line segments are located, and determine intersection points of any two straight lines in the plurality of second straight lines to obtain the plurality of second intersection points.

In embodiments of the present disclosure, the matching module 603 is specifically configured to: extract a first feature vector of the plurality of first intersection points and a second feature vector of the plurality of second intersection points by using arterial spin labeling (ASL); and determine the plurality of matching point pairs based on the distance between the first feature vector and the second feature vector.

In embodiments of the present disclosure, the first feature vector comprises first feature information corresponding to the plurality of first intersection points, and the second feature vector comprises second feature information corresponding to the plurality of second intersection points. The matching module 603 determines the plurality of matching point pairs based on the distance between the first feature vector and the second feature vector, and is specifically configured to: determine, for each first intersection point, a distance between the first intersection point and the plurality of second intersection points based on the first feature information of the first intersection point and the second feature information corresponding to the plurality of second intersection points; and select, from the plurality of second intersection points, a second intersection point meeting a preset distance threshold and having a minimum distance, and combine the selected second intersection point with the first intersection point as a matching point pair to obtain the plurality of matching point pairs.

In embodiments of the present disclosure, the second determining module 604 is specifically configured to: determine, for each matching point pair, a first target line segment associated with the first intersection point and a second target line segment associated with the second intersection point; determine a first slope of a straight line where the first target line segment is located and a second slope of a straight line where the second target line segment is located; and determine the plurality of matched target line segments in the first image and the second image based on the first slope and the second slope.

In embodiments of the present disclosure, the second determining module 604 determines the plurality of matched target line segments in the first image and the second image based on the first slope and the second slope, and is specifically configured to: determine a slope difference between the first slope and the second slope; and in accordance with a determination that the slope difference is less than the preset threshold, determine that the first target line segment and the second target line segment are matched target line segments, to obtain the plurality of matched target line segments in the first image and the second image.

The extracting module 601, the first determining module 602, the matching module 603 and the second determining module 604 are sequentially connected. The apparatus for image processing provided in this embodiment may perform the technical solutions of the above method embodiments, and implementation principles and technical effects thereof are similar, and details are not described herein again in this embodiment.

FIG. 7 is a schematic structural diagram of an electronic device according to embodiments of the present disclosure. As shown in FIG. 7, the electronic device 7 comprises a processor 701, and a memory 702 communicatively connected with the processor 701. The memory 702 stores computer-executable instructions. The processor 701 executes the computer-executable instructions stored in the memory 702 to perform the method for image processing in the embodiments shown in FIG. 2 to FIG. 5.

Optionally, the processor 701 and the memory 702 are connected by a bus 703.

Related descriptions may be understood with reference to related descriptions and effects corresponding to the steps in the embodiments corresponding to FIG. 2 to FIG. 5, which will not be described herein again.

Embodiments of the present disclosure provide a computer-readable storage medium storing computer-executable instructions that, when executed by a processor, causing the image processing provided in any one of the embodiments corresponding to FIG. 2 to FIG. 5 of this application to be performed.

FIG. 7 shows a schematic structural diagram of an electronic device 700 suitable for performing embodiments of the present disclosure, and the electronic device 700 may be a terminal device or a server. The terminal device may comprise, but is not limited to, a mobile terminal such as a mobile phone, a notebook computer, a digital broadcast receiver, a personal digital assistant (PDA), a portable android computer (PAD), a portable media player (PMP), an on-board terminal (e.g., an on-board navigation terminal), and a fixed terminal such as a digital TV, a desktop computer, or the like. The electronic device shown in FIG. 7 is merely an example, and should not bring any limitation to the functions and scope of use of the embodiments of the present disclosure.

As shown in FIG. 7, the electronic device 700 may comprise a processing device (e.g., a central processor, a graphics processor, etc.) 701, which may perform various appropriate actions and processing according to a program stored in a read only memory (ROM) 702 or a program loaded into a random access memory (RAM) 703 from a storage device 708. In the RAM 703, various programs and data required by the operation of the electronic device 700 are also stored. The processorg 701, the ROM 702, and the RAM 703 are connected to each other through a bus 704. An input/output (I/O) interface 705 is also connected to the bus 704.

Generally, the following devices may be connected to the I/O interface 705: an input device 706 including, for example, a touch screen, a touch pad, a keyboard, a mouse, a camera, a microphone, an accelerometer, a gyroscope, etc.; an output device 707 including, for example, a liquid crystal display (LCD), a speaker, a vibrator, etc.; a storage device 708 including, for example, a magnetic tape, a hard disk, etc.; and a communication device 709. The communication device 709 may allow the electronic device 700 to communicate wirelessly or wired with other devices to exchange data. While FIG. 7 shows the electronic device 700 having various devices, it should be understood that it is not required to implement or provide all illustrated devices. More or fewer devices may alternatively be implemented or provided.

In particular, according to embodiments of the present disclosure, the process described above with reference to the flowchart may be implemented as a computer software program. For example, embodiments of the present disclosure comprise a computer program product comprising a computer program carriedon a computer readable medium, the computer program comprising program code for performing the method shown in the flowchart. In such embodiments, the computer program may be downloaded and installed from the network through the communication device 709, or installed from the storage device 708, or installed from the ROM 702. When the computer program is executed by the processor 701, the above functions defined in the method of the embodiments of the present disclosure are performed.

It should be noted that the above computer-readable medium of the present disclosuremay be a computer-readable signal medium, a computer-readable storage medium, or any combination of both. For example, the computer-readable storage medium may be, but not limited to, an electrical, magnetic, optical, electromagnetic, infrared, or semiconductor system, apparatus, or device, or any combination thereof. More specific examples of computer-readable storage medium may comprise, but not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may comprise a data signal propagated in baseband or as part of a carrier, where the computer readable program code is carried. Such propagated data signals may take a variety of forms comprising, but not limited to, electromagnetic signals, optical signals, or any suitable combination of both. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, comprising, but not limited to: wires, optical cables, radio frequency (RF) , and the like, or any suitable combination thereof.

The computer-readable medium described above may be comprised in the electronic device described above; or may be separately present without being assembled into the electronic device.

The computer-readable medium described above carries one or more programs, and when the one or more programs described above are executed by the electronic device, the electronic device is caused to perform the method shown in the above embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In response to a remote computer, the remote computer may be connected to the user computer through any kind of network, comprising a local area network (LAN) or a wide area network (WAN), or may be connected to an external computer (e.g., through the internet using an Internet service provider).

The flowcharts and block diagrams in the drawingsillustrate architecture, function, and operation of possible implementations of systems, methods, and computer program products according to various embodiments of the present disclosure. In this regard, each block in the flowchart or block diagram may represent a part of a module, a program segment, or a code that includes one or more executable instructions for implementing the specified logical function. It should also be noted that in some alternative implementations, the functions noted in the blocks may also occur in a different order than that illustrated in the drawings. For example, two consecutively represented blocks may actually be performed substantially in parallel, and may sometimes be performed in the reverse order, depending on the function involved. It is also noted that each block in the block diagrams and/or flowcharts, andcombinations of blocks in the block diagrams and/or flowcharts, may be implemented with a dedicated hardware-based system that performs the specified functions or operations, or may be implemented with a combination of dedicated hardware and computer instructions.

The modules described in the embodiments of the present disclosure may be implemented by software, or may be implemented by hardware. The name of the module does not constitute a limitation to the module itself in some cases, for example, the first obtaining module may be further described as “module for obtaining at least two Internet Protocol addresses”.

The functions described above may be performed, at least in part, by one or more hardware logic components. For example, without limitation, exemplary types of hardware logic components that may be used comprise: field-programmable gate arrays (FPGA), application-specific integrated circuits (ASIC), application-specific standard products (ASSP), system-on-a-chip (SOC), complex programmable logic devices (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may comprise, but is not limited to, electronic, magnetic, optical, electromagnetic, infrared, or semiconductor systems, devices, or devices, or any suitable combination of the foregoing. More specific examples of machine-readable storage medium may comprise electrical connections based on one or more lines, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination of the foregoing.

According to one or more embodiments of the present disclosure, there is provided a method for image processing, comprising: performing line feature extraction on a first image and a second image to be matched, respectively, to obtain a plurality of first line segments and a plurality of second line segments; determining a plurality of first intersection points corresponding to the plurality of first line segments and a plurality of second intersection points corresponding to the plurality of second line segments; matching the plurality of first intersection points and the plurality of second intersection points to obtain a plurality of matching point pairs, wherein each matching point pair comprises a first intersection point and a corresponding second intersection point; and determining a plurality of matched target line segments in the first image and the second image based on the plurality of matching point pairs.

According to one or more embodiments of the present disclosure, the performing line feature extraction on a first image and a second image to be matched, respectively, to obtain a plurality of first line segments and a plurality of second line segments comprises: performing Gaussian down-sampling processing on the first image to obtain a plurality of first pixels, and performing Gaussian down-sampling processing on the second image to obtain a plurality of second pixels; determining gradients of the plurality of first pixels and gradients of the plurality of second pixels; and performing the line feature extraction on the first image based on the gradients of the plurality of first pixels to obtain the plurality of first line segments, and performing the line feature extraction on the second image based on the gradients of the plurality of second pixels to obtain the plurality of second line segments.

According to one or more embodiments of the present disclosure, line feature extraction on the first image based on the gradients of the plurality of first pixels to obtain the plurality of first line segments, and performing line feature extraction on the second image based on the gradients of the plurality of second pixels to obtain the plurality of second line segments comprises: determining a gradient direction of each first pixel based on the gradients of the plurality of first pixels, selecting a first seed pixel from the plurality of first pixels, performing region growing on the first seed pixel based on the gradient direction of each first pixel to obtain a first line support region, and determining a first line segment based on the first line support region; determining a gradient direction of each second pixel based on the gradients of the plurality of second pixels, selecting a second seed pixel from the plurality of second pixels, performing region growing on the second seed pixel based on the gradient direction of each second pixel to obtain a second line support region, and determining a second line segment based on the second line support region.

According to one or more embodiments of the present disclosure, the determining a plurality of first intersection points corresponding to the plurality of first line segments and a plurality of second intersection points corresponding to the plurality of second line segments comprises: determining a plurality of first straight lines where the plurality of first line segments are located, and determining intersection points of any two straight lines among the plurality of first straight lines to obtain the plurality of first intersection points; and determining a plurality of second straight lines where the plurality of second line segments are located, and determining intersection points of any two straight lines among the plurality of second straight lines to obtain the plurality of second intersection points.

According to one or more embodiments of the present disclosure, the matching the plurality of first intersection points and the plurality of second intersection points to obtain a plurality of matching point pairs comprises: extracting, by using arterial spin labeling, a first feature vector of the plurality of first intersection points and a second feature vector of the plurality of second intersection points; and determining the plurality of matching point pairs based on a distances between the first feature vector and the second feature vector.

According to one or more embodiments of the present disclosure, the first feature vector comprises first feature information corresponding to the plurality of first intersection points, and the second feature vector comprises second feature information corresponding to the plurality of second intersection points; the determining the plurality of matching point pairs based on a distances between the first feature vector and the second feature vector comprises: determining, for each first intersection point, a distance between the first intersection point and the plurality of second intersection points based on first feature information of the first intersection point and the second feature information corresponding to the plurality of second intersection points; and selecting, from the plurality of second intersection points, a second intersection point meeting a preset distance threshold and having a minimum distance, and combining the selected second intersection point with the first intersection point as a matching point pair to obtain the plurality of matching point pairs.

According to one or more embodiments of the present disclosure, the determining a plurality of matched target line segments in the first image and the second image based on the plurality of matching point pairs comprises: determining, for each matching point pair, a first target line segment associated with the first intersection point and a second target line segment associated with the second intersection point; determining a first slope of a straight line where the first target line segment is located and a second slope of a straight line where the second target line segment is located; and determining the plurality of matched target line segments in the first image and the second image based on the first slope and the second slope.

According to one or more embodiments of the present disclosure, the determining the plurality of matched target line segments in the first image and the second image based on the first slope and the second slope comprises: determining a slope difference between the first slope and the second slope; and in accordance with a determination that the slope difference is less than a preset threshold, determining that the first target line segment and the second target line segment are matched target line segments, to obtain the plurality of matched target line segments in the first image and the second image.

According to one or more embodiments of the present disclosure, the first image is real-time image data acquired by a camera, and the second image is image data corresponding to the first image and confirmed based on visual data of a map.

According to a second aspect, an apparatus for image processing is provided according to one or more embodiments of the present disclosure, comprising: an extracting module configured to perform line feature extraction on a first image and a second image to be matched, respectively, to obtain a plurality of first line segments and a plurality of second line segments; a first determining module configured to determine a plurality of first intersection points corresponding to the plurality of first line segments and a plurality of second intersection points corresponding to the plurality of second line segments; a matching module configured to match the plurality of first intersection points and the plurality of second intersection points to obtain a plurality of matching point pairs, wherein each matching point pair comprises a first intersection point and a corresponding second intersection point; and a second determining module configured to determine a plurality of matched target line segments in the first image and the second image based on the plurality of matching point pairs.

In embodiments of the present disclosure, the extracting module is specifically configured to: perform Gaussian down-sampling processing on the first image to obtain a plurality of first pixels, and perform Gaussian down-sampling processing on the second image to obtain a plurality of second pixels; determine gradients of the plurality of first pixels and gradients of the plurality of second pixels; perform the line feature extraction on the first image based on the gradients of the plurality of first pixels to obtain the plurality of first line segments, and perform the line feature extraction on the second image based on the gradients of the plurality of second pixels to obtain the plurality of second line segments.

In embodiments of the present disclosure, the extracting module performs line feature extraction on the first image based on the gradients of the plurality of first pixels to obtain the plurality of first line segments, and performs line feature extraction on the second image based on the gradients of the plurality of second pixels to obtain the plurality of second line segments, and is specifically configured to: determine a gradient direction of each first pixel based on the gradients of the plurality of first pixels, select a first seed pixel from the plurality of first pixels, perform region growing on the first seed pixel based on the gradient direction of each first pixel to obtain a first line support region, and determine a first line segment based on the first line support region; and determine a gradient direction of each second pixel based on the gradients of the plurality of second pixels, select a second seed pixel from the plurality of second pixels, perform region growing on the second seed pixel based on the gradient direction of each second pixel to obtain a second line support region, and determine a second line segment based on the second line support region.

In embodiments of the present disclosure, the first determining module is specifically configured to: determine a plurality of first straight lines where the plurality of first line segments are located, and determine intersection points of any two straight lines among the plurality of first straight lines to obtain the plurality of first intersection points; and determine a plurality of second straight lines where the plurality of second line segments are located, and determining intersection points of any two straight lines among the plurality of second straight lines to obtain the plurality of second intersection points.

In embodiments of the present disclosure, the matching module is specifically configured to: extract extract, by using arterial spin labeling, a first feature vector of the plurality of first intersection points and a second feature vector of the plurality of second intersection points; and determine the plurality of matching point pairs based on a distance between the first feature vector and the second feature vector.

In embodiments of the present disclosure, the first feature vector comprises first feature information corresponding to the plurality of first intersection points, and the second feature vector comprises second feature information corresponding to the plurality of second intersection points; the matching module determines a plurality of matching point pairs based on a distance between the first feature vector and the second feature vector, and is specifically configured to: determine, for each first intersection point, a distance between the first intersection point and the plurality of second intersection points based on first feature information of the first intersection point and the second feature information corresponding to the plurality of second intersection points; and select, from the plurality of second intersection points, a second intersection point meeting a preset distance threshold and having a minimum distance, and combine the selected second intersection point with the first intersection point as a matching point pair to obtain the plurality of matching point pairs.

In embodiments of the present disclosure, the second determining module is specifically configured to: determine, for each matching point pair, a first target line segment associated with the first intersection point and a second target line segment associated with the second intersection point; determine a first slope of a straight line where the first target line segment is located and a second slope of a straight line where the second target line segment is located; and determine the plurality of matched target line segments in the first image and the second image based on the first slope and the second slope.

In embodiments of the present disclosure, the second determining module determines a plurality of matched target line segments in the first image and the second image based on the first slope and the second slope, and the second determining module is specifically configured to: determine a slope difference between the first slope and the second slope; and in accordance with a determination that the slope difference is less than the preset threshold, determine that the first target line segment and the second target line segment are matched target line segments, to obtain the plurality of matched target line segments in the first image and the second image.

According to a third aspect, an electronic device is provided according to one or more embodiments of the present disclosure, comprising: a processor, and a memory communicatively connected to the processor; the memory storing computer-executable instructions; and the processor executing the computer-executable instructions stored in the memory to perform the method for image processing according to the first aspect and the possible designs of the first aspect.

According to a fourth aspect, a computer-readable storage medium is provided according to one or more embodiments of the present disclosure, wherein the computer-readable storage medium stores computer-executable instructions that, and when executed by a processor, causing the method for image processing according to the first aspect and the possible designs of the first aspect to be performed.

According to a fifth aspect, embodiments of the present disclosure provide a computer program product, including a computer program that, when executed by a processor, causing the method for image processing according to the first aspect and various possible designs of the first aspect to be performed.

The above description is merely an illustration of the preferred embodiments of the present disclosure and the principles of the application. It should be understood by those skilled in the art that the scope of the disclosure involved in the present disclosure is not limited to the technical solutions of the specific combination of the above technical features, and also cover other technical solutions formed by any combination of the above technical features or their equivalent features without departing from the above disclosed concept, for example, the technical solutions formed by mutually replacing the above features with technical features disclosed in the present disclosure (but not limited to).

Further, while operations are depicted in a particular order, this should not be understood as requiring these operations to be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1-13. (canceled)

14. A method for image processing, comprising:
performing line feature extraction on a first image and a second image to be matched, respectively, to obtain a plurality of first line segments and a plurality of second line segments;
determining a plurality of first intersection points corresponding to the plurality of first line segments and a plurality of second intersection points corresponding to the plurality of second line segments;
matching the plurality of first intersection points and the plurality of second intersection points to obtain a plurality of matching point pairs, wherein each matching point pair comprises a first intersection point and a corresponding second intersection point; and
determining a plurality of matched target line segments in the first image and the second image based on the plurality of matching point pairs.

15. The method according to claim 14, wherein the performing line feature extraction on a first image and a second image to be matched, respectively, to obtain a plurality of first line segments and a plurality of second line segments comprises:
performing Gaussian down-sampling processing on the first image to obtain a plurality of first pixels, and performing Gaussian down-sampling processing on the second image to obtain a plurality of second pixels;
determining gradients of the plurality of first pixels and gradients of the plurality of second pixels; and
performing the line feature extraction on the first image based on the gradients of the plurality of first pixels to obtain the plurality of first line segments, and performing the line feature extraction on the second image based on the gradients of the plurality of second pixels to obtain the plurality of second line segments.

16. The method according to claim 15, wherein the performing line feature extraction on the first image based on the gradients of the plurality of first pixels to obtain the plurality of first line segments, and performing line feature extraction on the second image based on the gradients of the plurality of second pixels to obtain the plurality of second line segments comprises:
determining a gradient direction of each first pixel based on the gradients of the plurality of first pixels, selecting a first seed pixel from the plurality of first pixels, performing region growing on the first seed pixel based on the gradient direction of each first pixel to obtain a first line support region, and determining a first line segment based on the first line support region; and
determining a gradient direction of each second pixel based on the gradients of the plurality of second pixels, selecting a second seed pixel from the plurality of second pixels, performing region growing on the second seed pixel based on the gradient direction of each second pixel to obtain a second line support region, and determining a second line segment based on the second line support region.

17. The method according to claim 14, wherein the determining a plurality of first intersection points corresponding to the plurality of first line segments and a plurality of second intersection points corresponding to the plurality of second line segments comprises:
determining a plurality of first straight lines where the plurality of first line segments are located, and determining intersection points of any two straight lines among the plurality of first straight lines to obtain the plurality of first intersection points; and
determining a plurality of second straight lines where the plurality of second line segments are located, and determining intersection points of any two straight lines among the plurality of second straight lines to obtain the plurality of second intersection points.

18. The method according to claim 14, wherein the matching the plurality of first intersection points and the plurality of second intersection points to obtain a plurality of matching point pairs comprises:
extracting, by using arterial spin labeling, a first feature vector of the plurality of first intersection points and a second feature vector of the plurality of second intersection points; and
determining the plurality of matching point pairs based on a distance between the first feature vector and the second feature vector.

19. The method according to claim 18, wherein the first feature vector comprises first feature information corresponding to the plurality of first intersection points, and the second feature vector comprises second feature information corresponding to the plurality of second intersection points; and
the determining the plurality of matching point pairs based on a distance between the first feature vector and the second feature vector comprises:
determining, for each first intersection point, distances between the first intersection point and the plurality of second intersection points based on first feature information of the first intersection point and the second feature information corresponding to the plurality of second intersection points; and
selecting, from the plurality of second intersection points, a second intersection point meeting a preset distance threshold and having a minimum distance, and combining the selected second intersection point with the first intersection point as a matching point pair to obtain the plurality of matching point pairs.

20. The method according to claim 14, wherein the determining a plurality of matched target line segments in the first image and the second image based on the plurality of matching point pairs comprises:
determining, for each matching point pair, a first target line segment associated with the first intersection point and a second target line segment associated with the second intersection point;
determining a first slope of a straight line where the first target line segment is located and a second slope of a straight line where the second target line segment is located; and
determining the plurality of matched target line segments in the first image and the second image based on the first slope and the second slope.

21. The method according to claim 20, wherein the determining the plurality of matched target line segments in the first image and the second image based on the first slope and the second slope comprises:
determining a slope difference between the first slope and the second slope; and
in accordance with a determination that the slope difference is less than a preset threshold, determining that the first target line segment and the second target line segment are matched target line segments, to obtain the plurality of matched target line segments in the first image and the second image.

22. The method according to claim 14, wherein the first image is real-time image data acquired by a camera, and the second image is image data corresponding to the first image and confirmed based on visual data of a map.

23. An electronic device, comprising:
a processor, and
a memory communicatively connected to the processor;
the memory storing computer-executable instructions;
wherein the processor executes the computer-executable instructions stored in the memory to perfom acts comprising:
performing line feature extraction on a first image and a second image to be matched, respectively, to obtain a plurality of first line segments and a plurality of second line segments;
determining a plurality of first intersection points corresponding to the plurality of first line segments and a plurality of second intersection points corresponding to the plurality of second line segments;
matching the plurality of first intersection points and the plurality of second intersection points to obtain a plurality of matching point pairs, wherein each matching point pair comprises a first intersection point and a corresponding second intersection point; and
determining a plurality of matched target line segments in the first image and the second image based on the plurality of matching point pairs.

24. The electronic device according to claim 23, wherein the performing line feature extraction on a first image and a second image to be matched, respectively, to obtain a plurality of first line segments and a plurality of second line segments comprises:
performing Gaussian down-sampling processing on the first image to obtain a plurality of first pixels, and performing Gaussian down-sampling processing on the second image to obtain a plurality of second pixels;
determining gradients of the plurality of first pixels and gradients of the plurality of second pixels; and
performing the line feature extraction on the first image based on the gradients of the plurality of first pixels to obtain the plurality of first line segments, and performing the line feature extraction on the second image based on the gradients of the plurality of second pixels to obtain the plurality of second line segments.

25. The electronic device according to claim 24, wherein the performing line feature extraction on the first image based on the gradients of the plurality of first pixels to obtain the plurality of first line segments, and performing line feature extraction on the second image based on the gradients of the plurality of second pixels to obtain the plurality of second line segments comprises:
determining a gradient direction of each first pixel based on the gradients of the plurality of first pixels, selecting a first seed pixel from the plurality of first pixels, performing region growing on the first seed pixel based on the gradient direction of each first pixel to obtain a first line support region, and determining a first line segment based on the first line support region; and
determining a gradient direction of each second pixel based on the gradients of the plurality of second pixels, selecting a second seed pixel from the plurality of second pixels, performing region growing on the second seed pixel based on the gradient direction of each second pixel to obtain a second line support region, and determining a second line segment based on the second line support region.

26. The electronic device according to claim 23, wherein the determining a plurality of first intersection points corresponding to the plurality of first line segments and a plurality of second intersection points corresponding to the plurality of second line segments comprises:
determining a plurality of first straight lines where the plurality of first line segments are located, and determining intersection points of any two straight lines among the plurality of first straight lines to obtain the plurality of first intersection points; and
determining a plurality of second straight lines where the plurality of second line segments are located, and determining intersection points of any two straight lines among the plurality of second straight lines to obtain the plurality of second intersection points.

27. The electronic device according to claim 23, wherein the matching the plurality of first intersection points and the plurality of second intersection points to obtain a plurality of matching point pairs comprises:
extracting, by using arterial spin labeling, a first feature vector of the plurality of first intersection points and a second feature vector of the plurality of second intersection points; and
determining the plurality of matching point pairs based on a distance between the first feature vector and the second feature vector.

28. The electronic device according to claim 27, wherein the first feature vector comprises first feature information corresponding to the plurality of first intersection points, and the second feature vector comprises second feature information corresponding to the plurality of second intersection points; and
the determining the plurality of matching point pairs based on a distance between the first feature vector and the second feature vector comprises:
determining, for each first intersection point, distances between the first intersection point and the plurality of second intersection points based on first feature information of the first intersection point and the second feature information corresponding to the plurality of second intersection points; and
selecting, from the plurality of second intersection points, a second intersection point meeting a preset distance threshold and having a minimum distance, and combining the selected second intersection point with the first intersection point as a matching point pair to obtain the plurality of matching point pairs.

29. The electronic device according to claim 23, wherein the determining a plurality of matched target line segments in the first image and the second image based on the plurality of matching point pairs comprises:
determining, for each matching point pair, a first target line segment associated with the first intersection point and a second target line segment associated with the second intersection point;
determining a first slope of a straight line where the first target line segment is located and a second slope of a straight line where the second target line segment is located; and
determining the plurality of matched target line segments in the first image and the second image based on the first slope and the second slope.

30. The electronic device according to claim 29, wherein the determining the plurality of matched target line segments in the first image and the second image based on the first slope and the second slope comprises:
determining a slope difference between the first slope and the second slope; and
in accordance with a determination that the slope difference is less than a preset threshold, determining that the first target line segment and the second target line segment are matched target line segments, to obtain the plurality of matched target line segments in the first image and the second image.

31. The electronic device according to claim 23, wherein the first image is real-time image data acquired by a camera, and the second image is image data corresponding to the first image and confirmed based on visual data of a map.

32. A non-transitory computer-readable storage medium storing computer-executable instructions that, when executed by a processor, causing acts to be performed, the acts comprising:
performing line feature extraction on a first image and a second image to be matched, respectively, to obtain a plurality of first line segments and a plurality of second line segments;
determining a plurality of first intersection points corresponding to the plurality of first line segments and a plurality of second intersection points corresponding to the plurality of second line segments;
matching the plurality of first intersection points and the plurality of second intersection points to obtain a plurality of matching point pairs, wherein each matching point pair comprises a first intersection point and a corresponding second intersection point; and
determining a plurality of matched target line segments in the first image and the second image based on the plurality of matching point pairs.

33. The non-transitory computer-readable storage medium according to claim 32, wherein the performing line feature extraction on a first image and a second image to be matched, respectively, to obtain a plurality of first line segments and a plurality of second line segments comprises:
performing Gaussian down-sampling processing on the first image to obtain a plurality of first pixels, and performing Gaussian down-sampling processing on the second image to obtain a plurality of second pixels;
determining gradients of the plurality of first pixels and gradients of the plurality of second pixels; and
performing the line feature extraction on the first image based on the gradients of the plurality of first pixels to obtain the plurality of first line segments, and performing the line feature extraction on the second image based on the gradients of the plurality of second pixels to obtain the plurality of second line segments.
